(19) United States
(12) Patent Application Publication
(10) Pub. No.: US 2019/0206224 A1
(43) Pub. Date: Jul. 4, 2019

(54) MANAGEMENT METHODS AND SYSTEMS FOR SUITCASE REMINDER

(71) Applicant: Noodoe Corporation, Taipei City (TW)

(72) Inventor: John C. Wang, Taipei City (TW)

(21) Appl. No.: 16/232,132

(22) Filed: Dec. 26, 2018

(30) Foreign Application Priority Data
Dec. 29, 2017 (TW) 106146376

(51) Int. Cl. G08B 21/24; G08B 25/10

(52) U.S. Cl. CPC G08B 21/24; G08B 25/10

(57) ABSTRACT

Management methods and systems for suitcase reminder for use in a suitcase and an electronic device are provided. A wireless connection unit of the suitcase transmits a wireless signal via a wireless network. The electronic device determines whether an execution condition is triggered or not. When the execution condition is triggered, it is determined whether the wireless signal transmitted by the suitcase is detected by the electronic device via the wireless network. When the wireless signal transmitted by the suitcase is detected by the electronic device via the wireless network, a reminder corresponding to the suitcase is generated via the electronic device.

### BACKGROUND OF THE INVENTION

### Field of the Invention

The disclosure relates generally to management methods and systems for suitcase reminder, and, more particularly to methods and systems that can perform related managements for the suitcase based on triggering of execution conditions and receipt of wireless signals.

### Description of the Related Art

Recently, electronic devices, such as smart phones, tablets, notebooks, and other portable devices, have become more and more technically advanced and multifunctional. For example, portable devices have network connectivity capabilities. Users can use their portable devices to connect to networks at anytime and anywhere. The convenience and new functionalities advanced by modern technology have made these devices into necessities of life.

Furthermore, with the coming of IOT (Internet Of Things) generation, every device or object can connect to networks, and users can access and control these devices or objects via networks. The rapid development of IOT is fortunate that the underlying foundation of wireless network technology is already very mature. Electronic devices can readily connect with each other to perform related applications via wireless networks. Additionally, the BLE (Bluetooth Low Energy) technology has solved the prohibitive power consumption issue caused by prolonged connections of electronic devices to wireless networks. For example, a beacon device is a low-cost wireless Bluetooth transmitter implemented with BLE technology, which can transmit Bluetooth signals via a wireless network for a long time. A mobile phone implemented with BLE technology can wirelessly seek Bluetooth signals to discover corresponding beacon device.

For passengers who taking the plane, suitcase/luggage checked in is necessary. However, users who want to check in suitcase might face with several inconvenient circumstances. For example, when arriving at the destination, the users must go to a carousel and wait for their suitcases. Since everyone is afraid of missing their suitcases and one carousel may hold the suitcases for passengers of multiple airplanes, the carousel will always be crowded with passengers who want to pick up the suitcase, which usually causing the carousel crowded and the owners of the suitcase cannot find and pick up their own suitcase. The entire process of picking up the suitcase usually causes a poor user experience.

### BRIEF SUMMARY OF THE INVENTION

Management methods and systems for suitcase reminder are provided, wherein related managements are performed for the suitcase based on triggering of execution conditions and receipt of wireless signals.

In an embodiment of a management method for suitcase reminder for use in a suitcase and an electronic device, a wireless connection unit of the suitcase is first utilized to transmit a wireless signal via a wireless network. Then, the electronic device determines whether an execution condition is triggered or not. When the execution condition is triggered, it is determined whether the wireless signal transmitted by the suitcase is detected by the electronic device via the wireless network. When the wireless signal transmitted by the suitcase is detected by the electronic device via the wireless network, a reminder corresponding to the suitcase is generated via the electronic device.

An embodiment of a management system for suitcase reminder for use in an electronic device comprises a wireless connection unit and a processing unit. The wireless connection unit detects a wireless signal transmitted by a suitcase via a wireless network. Then, the processing unit determines whether an execution condition is triggered or not. When the execution condition is triggered, the processing unit determines whether the wireless signal transmitted by the suitcase is detected by the electronic device via the wireless network. When the wireless signal transmitted by the suitcase is detected by the electronic device via the wireless network, the processing unit generates a reminder corresponding to the suitcase via the electronic device.

In another embodiment of a management method for suitcase reminder for use in a suitcase and an electronic device, a wireless connection unit of the suitcase is first utilized to transmit a wireless signal via a wireless network. Then, the electronic device determines whether an execution condition is triggered or not. When the execution condition is triggered, it is determined whether a presence status corresponding to the suitcase has been changed, wherein the electronic device detects a wireless signal transmitted by the suitcase via the wireless network to determine the presence status corresponding to the suitcase. When the presence status corresponding to the suitcase has been changed, a reminder corresponding to the suitcase is generated via the electronic device.

Another embodiment of a management system for suitcase reminder for use in an electronic device comprises a wireless connection unit and a processing unit. The wireless connection unit detects a wireless signal transmitted by a suitcase via a wireless network to determine a presence status corresponding to the suitcase. The processing unit determines whether an execution condition is triggered or not. When the execution condition is triggered, the processing unit determines whether the presence status corresponding to the suitcase has been changed. When the presence status corresponding to the suitcase has been changed, the processing unit generates a reminder corresponding to the suitcase via the electronic device

In some embodiments, the determination of whether the execution condition is triggered includes providing a plurality of candidate area information in the electronic device and obtaining a current position corresponding to the electronic devices. Then, it is determined whether the current position corresponding to the electronic device is located in one of the candidate area information. When the current position corresponding to the electronic device is located in one of the candidate area information, it is determined that the execution condition is triggered.

In some embodiments, the determination of whether the execution condition is triggered includes detecting, by a pressure sensor of the electronic device, at least a first pressure value corresponding to a first time point, a second pressure value corresponding to a second time point, and a third pressure value corresponding to a third time point, wherein the second time point is later than the first time point, and the third time point is later than the second time point value. Thereafter, it is determined whether a pressure difference between the first pressure value and the second pressure value is greater than a predetermined pressure difference, and whether the third pressure value is substantially equal to the first pressure value. When the pressure difference is greater than the predetermined pressure difference and the third pressure value is substantially equal to the first pressure value, it is determined that the execution condition is triggered.

In some embodiments, the determination of whether the execution condition is triggered includes determining whether an execution indication is received via a user interface of the electronic device. When the execution indication is received through the user interface, it is determined that the execution condition is triggered.

In some embodiments, it may be determined whether a signal strength of the wireless signal of the suitcase is greater than a threshold value. When the signal strength is greater than the threshold value, it is determined that the electronic device detects the wireless signal transmitted by the suitcase via the wireless network.

Management methods for suitcase reminder may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a management system for suitcase reminder of the invention;

FIG. 2 is a schematic diagram illustrating an embodiment of an electronic device of the invention;

FIG. 3 is a schematic diagram illustrating an embodiment of a suitcase of the invention;

FIG. 4 is a flowchart of an embodiment of a management method for suitcase reminder of the invention;

FIG. 5 is a flowchart of another embodiment of a management method for suitcase reminder of the invention;

FIG. 6 is a flowchart of an embodiment of a method for determining that an execution condition is triggered of the invention;

FIG. 7 is a flowchart of another embodiment of a method for determining that an execution condition is triggered of the invention;

FIG. 8 is a flowchart of another embodiment of a method for determining that an execution condition is triggered of the invention; and

FIG. 9 is a flowchart of an embodiment of a method for determining that a wireless signal is received of the invention.

### DETAILED DESCRIPTION OF THE INVENTION

Management methods and systems for suitcase reminder are provided.

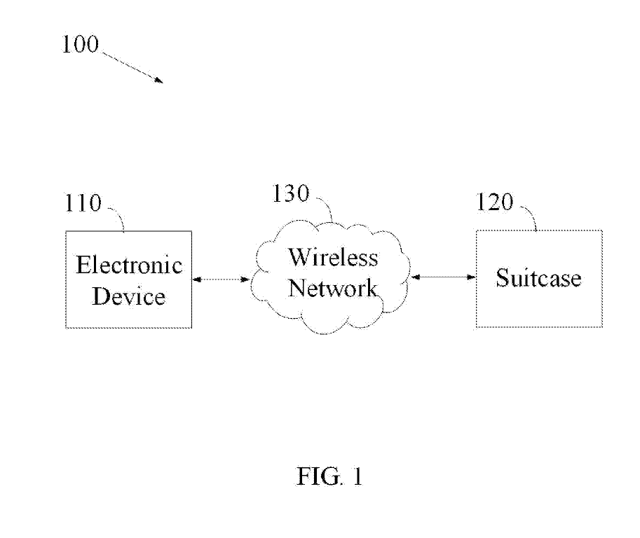

FIG. 1 is a schematic diagram illustrating an embodiment of a management system for suitcase reminder of the invention. The management system for suitcase reminder 100 comprises an electronic device 110 and a suitcase 120. In some embodiments, the electronic device 110 can be a portable device, such as a mobile phone, a smart phone, a PDA (Personal Digital Assistant), a GPS (Global Positioning System), a notebook, a wearable device or the like. It should be understood that, the electronic device 110 and the suitcase 120 can each have a wireless network connecting capability. In some embodiments, the electronic device 110 and the suitcase 120 are coupled to each other via a wireless network 130, such as Wi-Fi or Bluetooth network. It should be noted that in some embodiments, the suitcase 120 can include a device having BLE wireless transmission capabilities, such as Beacon, which continuously transmits a wireless signal.

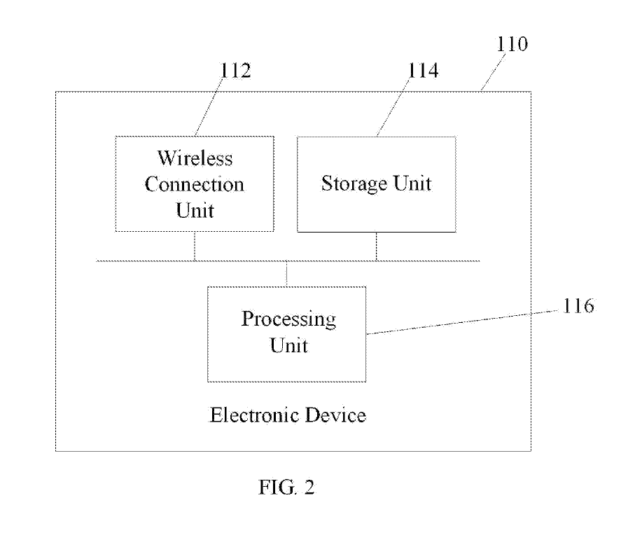

FIG. 2 is a schematic diagram illustrating an embodiment of an electronic device of the invention. As described above, the electronic device of the invention 110 can be a portable device, such as a mobile phone, a smart phone, a PDA (Personal Digital Assistant), a GPS (Global Positioning System), a notebook, a wearable device or the like. As shown in FIG. 2, the electronic device 110 comprises a wireless connection unit 112, a storage unit 114, and a processing unit 116. The wireless connection unit 112 can connect to other electronic devices having wireless connecting capabilities via a wireless network, such as Wi-Fi or Bluetooth network. It is understood that, in some embodiments, the wireless connection unit 112 may be a wireless connection unit implemented with a low-power consumption technology, such as Bluetooth Smart technology. The wireless connection unit 112 has two modes, such as a central mode and a peripheral mode. In the central mode, the wireless connection unit 112 can receive data from the wireless connection units of other electronic devices. In the peripheral mode, the wireless connection unit 112 can broadcast signals, such as its identification data. However, the wireless connection unit 112 cannot actively connect to other electronic devices in the peripheral mode. In some embodiments, the wireless network connecting unit 112 is in the central mode. The storage unit 114 can store related data, such as texts, images, and interfaces. In some embodiments, the storage unit 114 can store specific identification data corresponding to the suitcase 120. The specific identification data can be used to identify the suitcase 120. In some embodiments, the storage unit 114 may include multiple candidate area information, such as latitude and longitude information of airports in various countries, the use of which will be described later. The processing unit 116 can control related operations of software and hardware in the electronic device 110 to perform the management method for suitcase reminder of the invention, the details of which will be described later.

It should be noted that in some embodiments, the electronic device 110 may further comprise a display unit (not shown in FIG. 2) for displaying related data, such as user interfaces. In some embodiments, the electronic device 110 may further comprise a positioning unit (not shown in FIG. 2) for communicating with at least one satellite to obtain current location corresponding to the electronic device 110. In some embodiments, the electronic device 110 may further comprise a pressure sensor (not shown in FIG. 2) for detecting a pressure (atmospheric pressure) value of the environments in which the electronic device 110 is located.

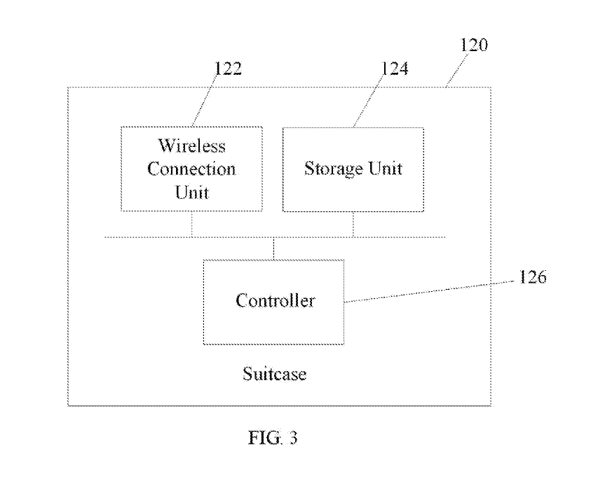

FIG. 3 is a schematic diagram illustrating an embodiment of a suitcase of the invention. The suitcase 112 comprises a wireless connection unit 122, a storage unit 124, and a controller 126. The wireless connection unit 122 can connect to other electronic devices having wireless connecting capabilities via a wireless network, such as Wi-Fi or Bluetooth network. It is understood that, in some embodiments, the wireless connection unit 122 may be a wireless connection unit implemented with a low-power consumption technology, such as Bluetooth Smart technology. The wireless connection unit 122 has two modes, such as a central mode and a peripheral mode. In the central mode, the wireless connection unit 122 can receive data from the wireless connection units of other electronic devices. In the peripheral mode, the network connecting unit 122 can broadcast signals, such as its identification data. However, the network connecting unit 122 cannot actively connect to other electronic devices in the peripheral mode. In some embodiments, the wireless network connecting unit 122 is in the peripheral mode. In other words, the wireless network connecting unit 122 has data broadcasting capabilities, and the wireless network connecting unit 122 cannot actively connect to other electronic devices, wherein the wireless network connecting unit 122 can be passively connected to other electronic devices. The storage unit 124 can store related data, such as identification data for identifying the suitcase 120. Similarly, the identification data can be used to identify the suitcase 120. The controller 126 can be coupled to the wireless connection unit 122 and the storage unit 124 and control their operations.

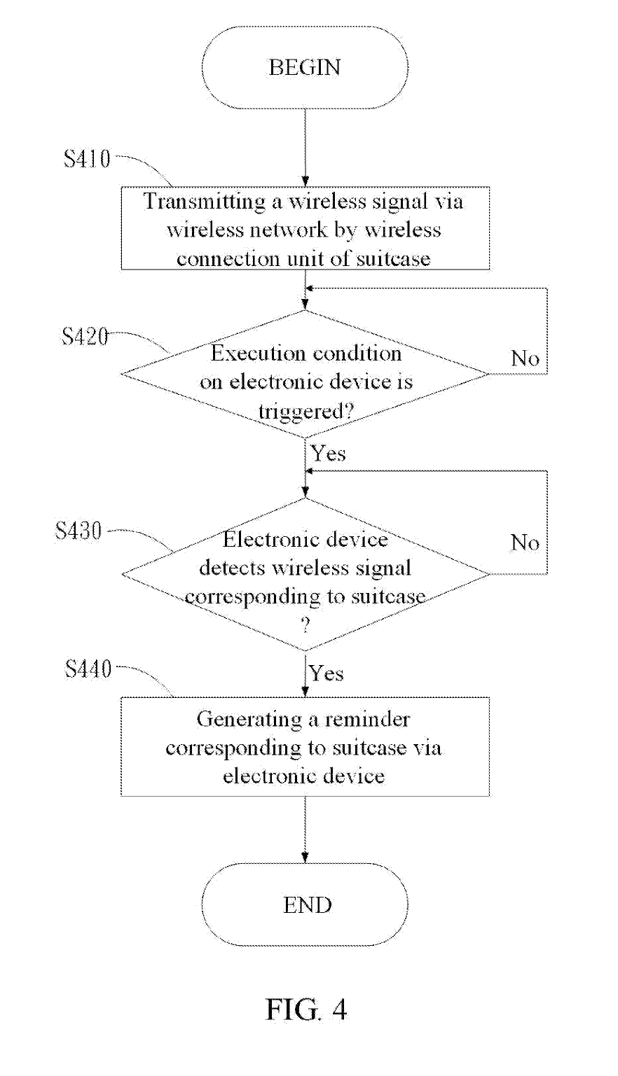

FIG. 4 is a flowchart of an embodiment of a management method for suitcase reminder of the invention. The management method for suitcase reminder of the invention can be used in an electronic device, such as a mobile phone, a smart phone, a PDA, a GPS, a notebook, a tablet computer, a wearable device, or other portable devices, and a suitcase.

First, in step S410, a wireless signal is transmitted via a wireless network, such as Wi-Fi or Bluetooth network, by a wireless connection unit of the suitcase. It should be noted that, in some embodiments, the wireless connection unit of the suitcase may be a network connecting unit implemented with a low-power consumption technology, such as Bluetooth Smart technology. The network connecting unit has two modes, specifically a central mode and a peripheral mode. In the central mode, the network connecting unit can receive data from the wireless connection units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless connection unit of the suitcase is in the peripheral mode. In other words, the wireless connection unit has data broadcasting capabilities, and the wireless connection unit cannot actively connect to other electronic devices, wherein the wireless connection unit can be passively connected to other electronic devices. It should be noted that in some embodiments, the suitcase can include a device having BLE wireless transmission capabilities, such as Beacon, which continuously transmits a wireless signal. In step S420, it is determined whether an execution condition on the electronic device is triggered. It is noted that the content of the execution condition and the determination method thereof will be described later. When the execution condition is not triggered (No in step S420), the determination in step S420 is continued. When the execution condition is triggered (Yes in step S420), in step S430, it is determined whether the electronic device detects the wireless signal transmitted by the corresponding suitcase via the wireless network. It should be noted that in some embodiments, the wireless connection unit of the electronic device may be a network connecting unit implemented with a low-power consumption technology, such as Bluetooth Smart technology. The network connecting unit has two modes, specifically a central mode and a peripheral mode. In the central mode, the network connecting unit can receive data from the wireless connection units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless connection unit of the electronic device is in the central mode. It is understood that in some embodiments, the suitcase and the electronic device may first perform a pairing operation, thereby recording identification data of the suitcase in the electronic device. In some embodiments, when the electronic device receives a wireless signal, it may first compare whether the identification data recorded in the wireless signal is the identification data of the corresponding suitcase recorded internally to confirm that the received wireless signal is transmitted by the suitcase. When the electronic device does not detect the wireless signal transmitted by the corresponding suitcase via the wireless network (No in step S430), the determination in step S430 is continued. When the electronic device detects the wireless signal transmitted by the corresponding suitcase via the wireless network (Yes in step S430), in step S440, a reminder corresponding to the suitcase is generated via the electronic device. It is understood that, in some embodiments, the aforementioned reminder can be information displayed via a display unit of the electronic device. In some embodiments, the aforementioned reminder can be a sound generated and output via a sound output unit of the electronic device. In some embodiments, the aforementioned reminder may be a vibration generated via a vibration unit of the electronic devices. It is noted that, above reminders are merely examples of the application, and the present invention is not limited thereto. Any reminder mechanism can be also applied to the present invention.

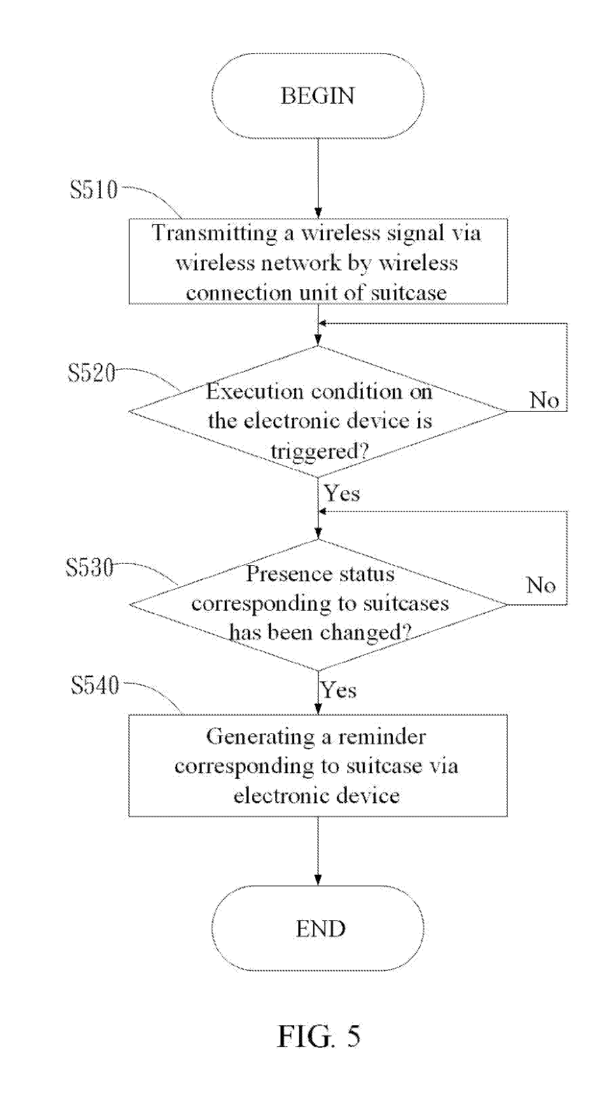

FIG. 5 is a flowchart of another embodiment of a management method for suitcase reminder of the invention. The management method for suitcase reminder of the invention can be used in an electronic device, such as a mobile phone, a smart phone, a PDA, a GPS, a notebook, a tablet computer, a wearable device, or other portable devices, and a suitcase.

First, in step S510, a wireless signal is transmitted via a wireless network, such as Wi-Fi or Bluetooth network, by a wireless connection unit of the suitcase. It should be noted that, in some embodiments, the wireless connection unit of the suitcase may be a network connecting unit implemented with a low-power consumption technology, such as Bluetooth Smart technology. The network connecting unit has two modes, specifically a central mode and a peripheral mode. In the central mode, the network connecting unit can receive data from the wireless connection units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless connection unit of the suitcase is in the peripheral mode. In other words, the wireless connection unit has data broadcasting capabilities, and the wireless connection unit cannot actively connect to other electronic devices, wherein the wireless connection unit can be passively connected to other electronic devices. It should be noted that in some embodiments, the suitcase can include a device having BLE wireless transmission capabilities, such as Beacon, which continuously transmits a wireless signal. In step S520, it is determined whether an execution condition on the electronic device is triggered. It is noted that the content of the execution condition and the determination method thereof will be described later. When the execution condition is not triggered (No in step S520), the determination in step S520 is continued. When the execution condition is triggered (Yes in step S520), in step S530, it is determined whether a presence status corresponding to the suitcases has been changed. It is noted that, the electronic device can detect a wireless signal transmitted by the corresponding suitcase via a wireless network to determine the presence status. Similarly, in some embodiments, the wireless connection unit of the electronic device may be a network connecting unit implemented with a low-power consumption technology, such as Bluetooth Smart technology. The network connecting unit has two modes, specifically a central mode and a peripheral mode. In the central mode, the network connecting unit can receive data from the wireless connection units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the wireless connection unit of the electronic device is in the central mode. Similarly, in some embodiments, the suitcase and the electronic device may perform a pairing operation to record identification data of the suitcase in the electronic device. In some embodiments, when the electronic device receives a wireless signal, it may first compare whether the identification data recorded in the wireless signal is the identification data of the corresponding suitcase recorded internally to confirm that the received wireless signal is transmitted by the suitcase. It should be noted that the presence status of the corresponding suitcase may be changed from a status that the wireless signal of the corresponding suitcase can be detected to that the wireless signal of the corresponding suitcase, and/or it may be changed from a status that the wireless signal of the corresponding suitcase cannot be detected to that the wireless signal of the corresponding suitcase can be detected corresponding suitcase cannot be detected. When the presence status of the corresponding suitcase has not been changed (No in step S530), the determination in step S530 is continued. When the presence status of the corresponding suitcase has been changed (Yes in step S530), in step S540, a reminder corresponding to the suitcase is generated via the electronic device. Similarly, in some embodiments, the aforementioned reminder can be information displayed via a display unit of the electronic device. In some embodiments, the aforementioned reminder can be a sound generated and output via a sound output unit of the electronic device. In some embodiments, the aforementioned reminder may be a vibration generated via a vibration unit of the electronic devices. It is noted that, above reminders are merely examples of the application, and the present invention is not limited thereto. Any reminder mechanism can be also applied to the present invention.

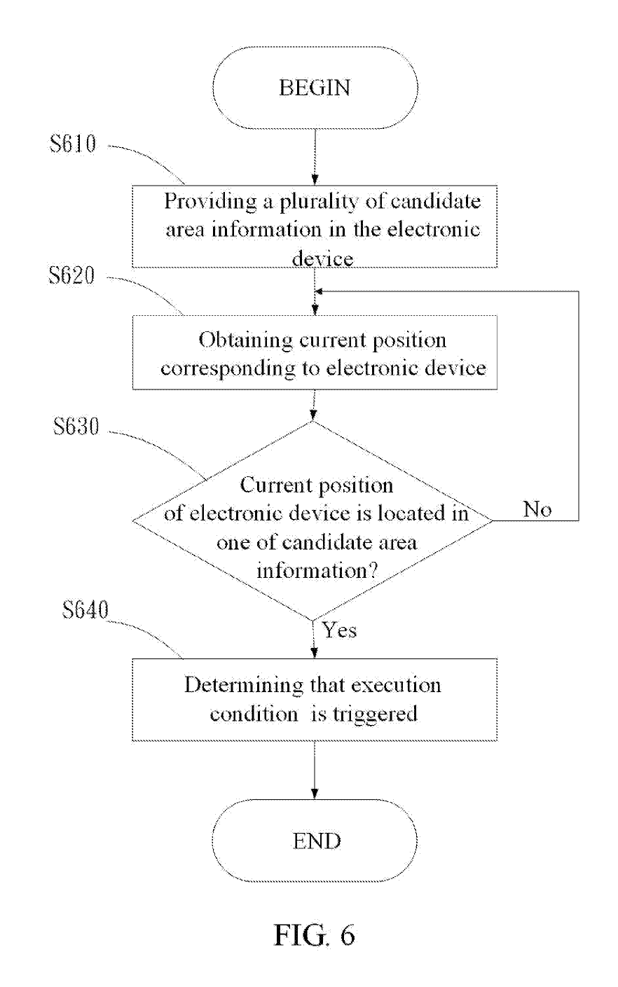

FIG. 6 is a flowchart of an embodiment of a method for determining that an execution condition is triggered of the invention. The method for determining that an execution condition is triggered of the invention can be used in an electronic device.

First, in step S610, a plurality of candidate area information is provided in the electronic device. It should be noted that, in some embodiments, the candidate area information may be latitude and longitude information of airports corresponding to different countries or regions. In step S620, a current position corresponding to the electronic device is obtained. As described above, in some embodiments, the electronic device can comprise a positioning unit for communicating with at least one satellite to obtain the current position corresponding to the electronic device. In step S630, it is determined whether the current position corresponding to the electronic device is located in one of the candidate area information. When the current position of the corresponding electronic device is not located in one of the candidate area information (No in step S630), the procedure returns to step S620. When the current position corresponding to the electronic device is located in one of the candidate area information (Yes in step S630), in step S640, it is determined that the execution condition in the electronic device is triggered.

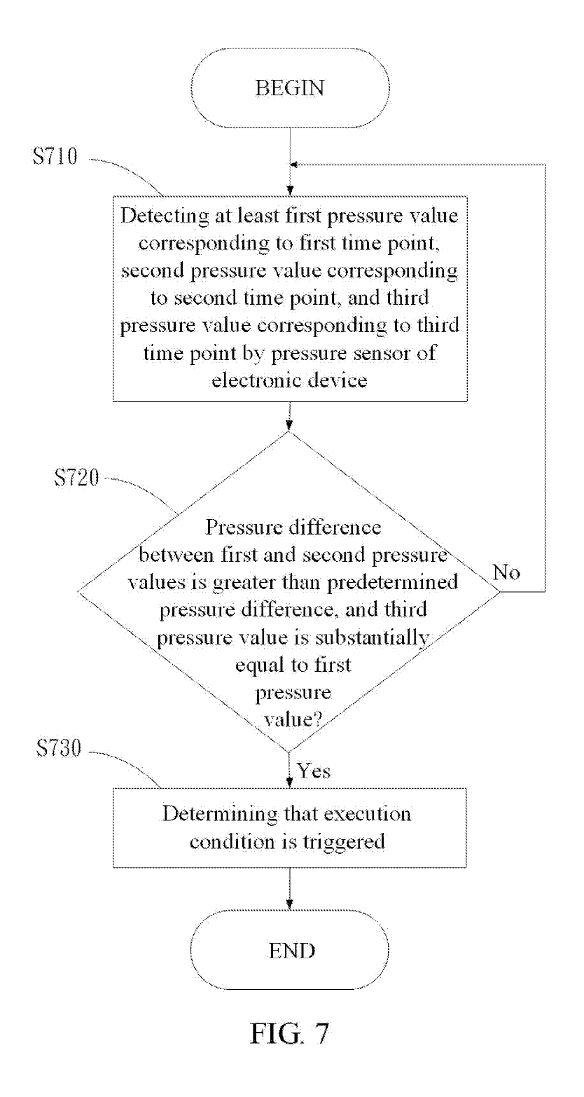

FIG. 7 is a flowchart of another embodiment of a method for determining that an execution condition is triggered of the invention. The method for determining that an execution condition is triggered of the invention can be used in an electronic device.

First, in step S710, at least a first pressure value corresponding to a first time point, a second pressure value corresponding to a second time point, and a third pressure value corresponding to a third time point are detected by a pressure sensor of the electronic device, wherein the second time point is later than the first time point, and the third time point is later than the second time point. It should be noted that, in some embodiments, the pressure sensor can continuously detect and record the pressure value of the environment in which the electronic device is located for a predetermined time period. The first time point, the second time point, the third time point, the first pressure value, the second pressure value, and the third pressure value can be obtained by analyzing the pressure values in the predetermined period. In some embodiments, the first time point and the third time point may be the time point at which the pressure value is the highest, and the second time point may be the time point at which the pressure value is the lowest. In step S720, it is determined whether a pressure difference between the first pressure value and the second pressure value is greater than a predetermined pressure difference, and whether the third pressure value is substantially equal to the first pressure value. When it is determined that the pressure difference between the first pressure value and the second pressure value is not greater than the predetermined pressure difference, or the third pressure value is not substantially equal to the first pressure value (No in step S720), the procedure returns to step S710. When it is determined that the pressure difference between the first pressure value and the second pressure value is greater than the predetermined pressure difference, and the third pressure value is substantially equal to the first pressure value (Yes in step S720), in step S730, it is determined that the execution condition in the electronic device is triggered.

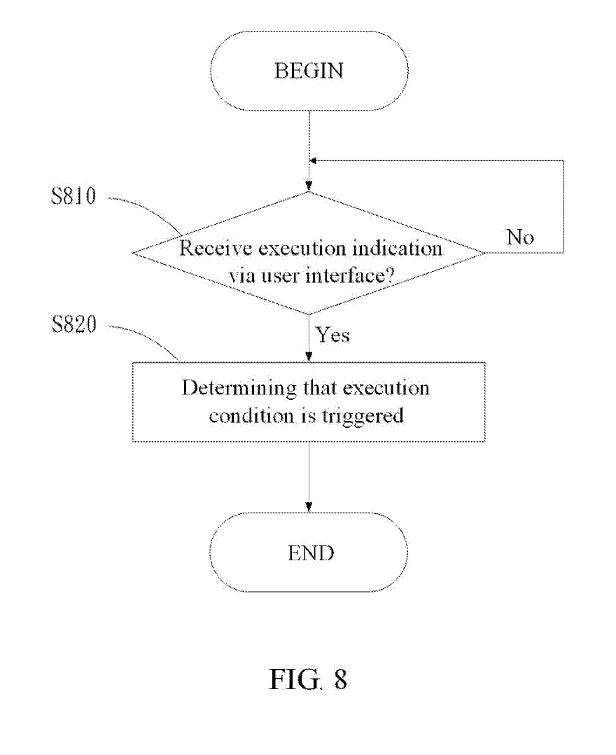

FIG. 8 is a flowchart of another embodiment of a method for determining that an execution condition is triggered of the invention. The method for determining that an execution condition is triggered of the invention can be used in an electronic device.

First, in step S810, it is determined whether an execution indication is received via a user interface of the electronic device. It is noted that, in some embodiments, an option may be displayed in the user interface. When this option is being selected, it indicates that this execution indication is generated. When the execution indication is not received via the user interface of the electronic device (No in step S810), the determination in step S810 is continued. When the execution indication is received via the user interface of the electronic device (Yes in step S810), in step S820, it is determined that the execution condition in the electronic device is triggered.

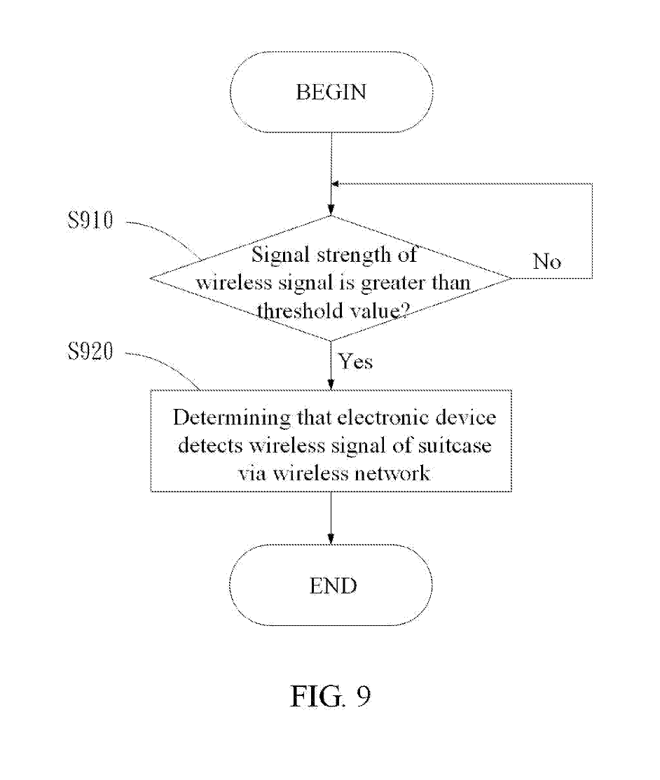

FIG. 9 is a flowchart of an embodiment of a method for determining that a wireless signal is received of the invention. In step S910, it is determined whether the signal strength corresponding to the wireless signal of the suitcase is greater than a threshold value. It is understood that, the electronic device can detect the wireless signal transmitted by the corresponding suitcase via a wireless network, such as WiFi network or Bluetooth network. Similarly, in some embodiments, the suitcase includes a device having BLE wireless communication capabilities, such as Beacon, which continuously transmits a wireless signal. It should be noted that, the signal strength corresponding to the wireless signal can be determined by the RSSI (Received Signal Strength Indication) value in the signal. When the signal strength corresponding to the wireless signal of the suitcase is not greater than the threshold value (No in step S910), the determination in step S910 is continued. When the signal strength corresponding to the wireless signal of the suitcase is greater than the threshold value (Yes in step S910), in step S920, it is determined that the electronic device detects the wireless signal transmitted by the corresponding suitcase via the wireless network.

For example, after the user takes the airplane to the airport of another country, since the current position of the electronic device is found in the candidate area information (airport latitude and longitude information), the execution condition would be triggered, and the relevant determination will be executed at the same time. In this example, the user does not have to be in front of the crowded carousel to wait for the suitcase. When the suitcase checked-in has been put on the carousel, in other words, when the electronic device detects the wireless signal of the corresponding suitcase, a reminder is generated via the electronic device. The user can pick up the suitcase on the carousel after receiving the reminder. In another example, after the user takes the airplane to the airport of another country, as the electronic device detects the take-off and landing of the airplane through the change of the environment air pressure, the execution condition is triggered, and the relevant determinations will be executed. Similarly, when the electronic device detects the wireless signal of the corresponding suitcase, a reminder will be generated via the electronic device. In another example, after the user takes the airplane to the airport of another country, the user can input an execution indication to the electronic device to trigger relevant determination via the user interface of the electronic device. Similarly, when the electronic device detects the wireless signal of the corresponding suitcase, a reminder will be generated via the electronic device.

Therefore, the management methods and systems for suitcase reminder of the present invention can perform related managements for the suitcase according to the triggering of the execution conditions and the receipt of the wireless signals, thereby combining technical technology to overcome the inconvenience of the prior art, and improving the efficiency of related operations.

Management methods for suitcase reminder, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A management method for suitcase reminder for use in a suitcase and an electronic device, comprising:
transmitting a wireless signal via a wireless network by a wireless connection unit of the suitcase;
determining whether an execution condition is triggered by the electronic device;
when the execution condition is triggered, determining whether the wireless signal transmitted by the suitcase is detected by the electronic device via the wireless network; and
when the wireless signal transmitted by the suitcase is detected by the electronic device via the wireless network, generating a reminder corresponding to the suitcase via the electronic device.

2. The management method of claim 1, wherein the determination of whether the execution condition is triggered comprises the steps of:
providing a plurality of candidate area information in the electronic device;
obtaining a current position corresponding to the electronic device;
determining whether the current position corresponding to the electronic device is located in one of the candidate area information; and
determining that the execution condition is triggered when the current position corresponding to the electronic device is located in one of the candidate region information.

3. The management method of claim 1, wherein the determination of whether the execution condition is triggered comprises the steps of:
detecting, by a pressure sensor of the electronic device, at least a first pressure value corresponding to a first time point, a second pressure value corresponding to a second time point, and a third pressure value corresponding to a third time point, wherein the second time point is later than the first time point, and the third time point is later than the second time point value;
determining whether a pressure difference between the first pressure value and the second pressure value is greater than a predetermined pressure difference, and whether the third pressure value is substantially equal to the first pressure value; and
determining that the execution condition is triggered when the pressure difference is greater than the predetermined pressure difference and the third pressure value is substantially equal to the first pressure value.

4. The management method of claim 1, wherein the determination of whether the execution condition is triggered comprises the steps of:
determining whether an execution indication is received via a user interface of the electronic device; and
determining that the execution condition is triggered when the execution indication is received through the user interface.

5. The management method of claim 1, further comprising:
determining whether a signal strength of the wireless signal of the suitcase is greater than a threshold value; and
determining that the electronic device detects the wireless signal transmitted by the suitcase via the wireless network when the signal strength is greater than the threshold value.

6. A management system for suitcase reminder for use in an electronic device, comprising:
a wireless connection unit detecting a wireless signal transmitted by a suitcase via a wireless network; and
a processing unit coupled to the wireless connection unit for determining whether an execution condition is triggered, and determining whether the wireless signal transmitted by the suitcase is detected by the electronic device via the wireless network when the execution condition is triggered, and when the wireless signal transmitted by the suitcase is detected by the electronic device via the wireless network, the processing unit generates a reminder corresponding to the suitcase via the electronic device.

7. A management method for suitcase reminder for use in a suitcase and an electronic device, comprising:
transmitting a wireless signal via a wireless network by a wireless connection unit of the suitcase;
determining whether an execution condition is triggered by the electronic device;
when the execution condition is triggered, determining whether a presence status corresponding to the suitcase has been changed, wherein the electronic device detects a wireless signal transmitted by the suitcase via the wireless network to determine the presence status corresponding to the suitcase; and
when the presence status corresponding to the suitcase has been changed, generating a reminder corresponding to the suitcase via the electronic device.

8. A management system for suitcase reminder for use in an electronic device, comprising:
a wireless connection unit detecting a wireless signal transmitted by a suitcase via a wireless network to determine a presence status corresponding to the suitcase; and
a processing unit coupled to the wireless connection unit for determining whether an execution condition is triggered by the electronic device and when the execution condition is triggered, determines whether the presence status corresponding to the suitcase has been changed, and when the presence status corresponding to the suitcase has been changed, the processing unit generates a reminder corresponding to the suitcase via the electronic device.

9. A machine-readable storage medium comprising a computer program, which, when executed, causes a device to perform a management method for suitcase reminder for use in an electronic device, wherein the method comprises:
detecting a wireless signal transmitted by a suitcase via a wireless network;
determining whether an execution condition is triggered;
determining whether the wireless signal transmitted by the suitcase is detected by the electronic device via the wireless network when the execution condition is triggered; and
generating a reminder corresponding to the suitcase via the electronic device when the wireless signal transmitted by the suitcase is detected by the electronic device via the wireless network.

10. A machine-readable storage medium comprising a computer program, which, when executed, causes a device to perform a management method for suitcase reminder for use in an electronic device, wherein the method comprises:
detecting a wireless signal transmitted by a suitcase via a wireless network to determine a presence status corresponding to the suitcase;
determining whether an execution condition is triggered;
determining whether the presence status corresponding to the suitcase has been changed when the execution condition is triggered; and
generating a reminder corresponding to the suitcase via the electronic device when the presence status corresponding to the suitcase has been changed.
